(19) United States
(12) Patent Application Publication
(10) Pub. No.: US 2004/0038118 A1
(43) Pub. Date: Feb. 26, 2004

(54) Fuel cell assembly

(76) Inventors: Marc Steinfort, Ismaning (DE); Marc Bednarz, Taufkirchen (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/416,728

(22) PCT Filed: Nov. 13, 2001
(86) PCT No.: PCT/EP01/13091

(30) Foreign Application Priority Data
Nov. 15, 2000 (DE) 100 56 534.4

(51) Int. Cl. H01M 4/86; H01M 8/02; H01M 8/24

(52) U.S. Cl. 429/44; 429/38; 429/37

(57) ABSTRACT

The invention relates to a fuel cell assembly with fuel cells arranged in the form of a fuel cell stack. The fuel cells each comprise an anode, a cathode and an electrolyte matrix arranged therebetween, and are separated from one another and electrically contacted by bipolar plates. Current collectors are respectively provided on the electrodes for electrically contacting the same and for guiding combustion gas or cathode gas thereon. In addition, means are provided for supplying and carrying away combustion gas and cathode gas to and from the fuel cells. A means that generates a pretensioning force subjects the fuel cells inside the fuel cell stack to a mutual pretensioning in the longitudinal direction of the fuel cell stack. According to the invention, the fuel cell stack is horizontally arranged when in operation, and the pretensioning force of the fuel cells exerts a uniform force upon all cells, is small and can be variably adapted to the operating state of the fuel cell assembly.

This application claims the priority of International Application No. PCT/EP01/13091, filed Nov. 13, 2001, and German Patent Document No. 100 56 534.4, filed Nov. 15, 2000, the disclosures of which are both incorporated by reference herein.

### BACKGROUND AND SUMMARY OF THE INVENTION

The present invention relates to a fuel cell assembly.

There exist fuel cell assemblies with fuel cells arranged in the form of a fuel cell stack. Each fuel cell exhibits an anode, a cathode, and an electrolyte matrix, arranged between said anode and cathode. The fuel cells are separated from one another by bipolar plates and are electrically contacted. Current collectors are respectively provided on the anodes for electrically contacting the same and for guiding combustion gas to the same; and current collectors are provided on the cathodes for electrically contacting the same and for guiding cathode gas to the same. Furthermore, there are means for supplying and carrying away combustion gas and cathode gas to and from the fuel cells, as well as means that generate a pre-stressing force and by means of which the fuel cells inside the fuel cell stack are subjected to a mutual pre-stressing in the longitudinal direction of the fuel cell stack.

The fuel cell stack of the conventional fuel cell assemblies of this type is usually arranged vertically when in operation, thus subjecting all of the fuel cells to a mandatory external pre-stressing force and in addition loading the bottom cells with the dead weight of the upper cells. So that, nevertheless, all of the cells are subjected to a uniform pre-stress and load, a high external pre-stressing force is applied. This high mechanical pre-stress results necessarily in all of the components of the fuel cells, which are subjected to these high pre-stressing forces, having to be made correspondingly strong and stable. Thus, components and materials that cannot withstand such high pre-stresses are not appropriate for manufacturing such conventional fuel cell assemblies.

The object of the invention is to disclose an improved fuel cell assembly. In particular, the invention shall provide a fuel cell assembly, in which there is greater freedom in the choice of the material used in the fuel cells.

The invention provides a fuel cell assembly with fuel cells, arranged in the form of a fuel cell stack. Each fuel cell comprises an anode, a cathode, and an electrolyte matrix, arranged between said anode and cathode. The fuel cells are separated from one another by bipolar plates and are electrically contacted. Current collectors are respectively provided on the anodes for electrically contacting the same and for guiding combustion gas to the same; and current collectors are provided on the cathodes for electrically contacting the same and for guiding cathode gas to the same. Furthermore, there are means for supplying and carrying away combustion gas and cathode gas to and from the fuel cells, as well as means that generate a pre-stressing force and by means of which the fuel cells inside the fuel cell stack are subjected to a mutual pre-stressing in the longitudinal direction of the fuel cell stack. The invention provides that the fuel cell stack is arranged horizontally when in operation and that the pre-stressing force of the fuel cells is small, can be variably adapted to the operating state of the fuel cell assembly, and exerts a uniformly large force on all of the cells.

A significant advantage of the inventive fuel cell assembly is that a reduction in the pre-stress results in higher degrees of freedom for the choice of material and for the design of the fuel cells and that the pre-stressing force can be variably adapted to the different operating states of the fuel cells.

A preferred design of the inventive fuel cell assembly provides that the means generating the pre-stressing force generate a high pre-stressing force at the startup of the fuel cell assembly and subsequently reduce the pre-stressing force. This enables a balancing of the tolerances and a setting of the fuel cell stack at startup of the fuel cell assembly; and, when the fuel cell assembly is in operation, a reduction in the creep of the components owing to the reduced pre-stress and an increase in the lifespan of the materials used in the fuel cells.

Following startup, the pre-stressing force is varied, in order to hold the pressure forces in the stack essentially equal.

One embodiment provides that the means generating the pre-stressing force are formed by means of a device that subjects the fuel cell stack to pre-stress from the outside in its longitudinal direction.

An advantageous further development of the inventive fuel cell assembly provides that materials producing an increase in volume are provided in the interior of the fuel cell stack. The advantage hereof lies in the fact that the increase in volume of such materials results in an automatic balancing of the manufacturing tolerances and a balancing of the setting procedure inside the fuel cell stack, as well as also an increase in the pre-stress applied to the fuel cell stack.

Preferably the materials producing an increase in volume are provided in the fuel cells.

A preferred embodiment of the inventive fuel cell assembly provides that the materials producing an increase in volume suffer an increase in volume at the startup of the fuel cell assembly.

Preferably the increase in volume is induced by a chemical change in the materials producing an increase in volume.

An advantageous embodiment of the invention provides that the materials producing an increase in volume are contained in the electrodes and/or matrix of the fuel cells.

Preferably the materials producing an increase in volume are contained in the cathodes of the fuel cells.

A preferred embodiment provides that the materials producing an increase in volume are made by means of a porous sintered nickel structure, which is provided on the cathodes and which is oxidized with a simultaneous increase in volume when the fuel cell assembly is started.

Preferably the porous sintered nickel structure is in the form of a foamed nickel material with a solid content ranging from 4% to approximately 75%, preferably ranging from 4% to 35%.

An especially preferred embodiment of the invention provides that the current collectors are formed by means of the porous sintered nickel structure and that the electrodes are provided in the form of a layer on the porous structure forming the current collectors.

Preferably flow paths are provided in the form of channels for guiding the combustion gas and/or the cathode gas in the porous structure forming the current collectors.

Another advantageous embodiment of the invention provides that materials producing an increase in volume are contained in the matrices of the fuel cells. Such an increase in volume increases the contact pressure of the matrix against the electrodes and enables the matrix to follow a thermally induced expansion of the metallic components in the area of the matrix.

According to an advantageous embodiment of the invention, the matrices of the fuel cells are made of the base materials, which form an aluminate, in particular lithium aluminate; an oxide, in particular zirconium dioxide; and/or a zirconate, in particular lithium zirconate, when the fuel cell assembly is started.

Another further development of the invention provides that the prestress generated at the fuel cell stack can be reduced after the fuel cell assembly is started. This feature has the advantage that a creep of the components, contained in the fuel cell stack or in the fuel cells, is reduced and the lifespan of the components is increased.

According to one aspect of the invention, the pre-stress is reduced by balancing the tolerances and setting the components, contained in the fuel cell stack, in particular in the fuel cells.

Another aspect of the invention provides that the pre-stress is reduced by reducing the pre-stress applied to the fuel cell stack from the outside.

### BRIEF DESCRIPTION OF THE DRAWINGS

Embodiments of the invention are explained below with reference to the drawings.

FIG. 1 is a schematic side view of the construction of the fuel cell, according to one embodiment of the invention.

FIG. 2 is a schematic view showing the horizontal arrangement of the fuel cell stack, according to one aspect of the invention; and

FIGS. 3 and 4 are schematic enlarged cross sectional views of a detail of a porous structure, forming a current collector, with an electrode, arranged thereon, and/or a perspective view of the porous structure alone, forming the current collector, in accordance with an embodiment of the invention.

### DETAILED DESCRIPTION OF THE DRAWINGS

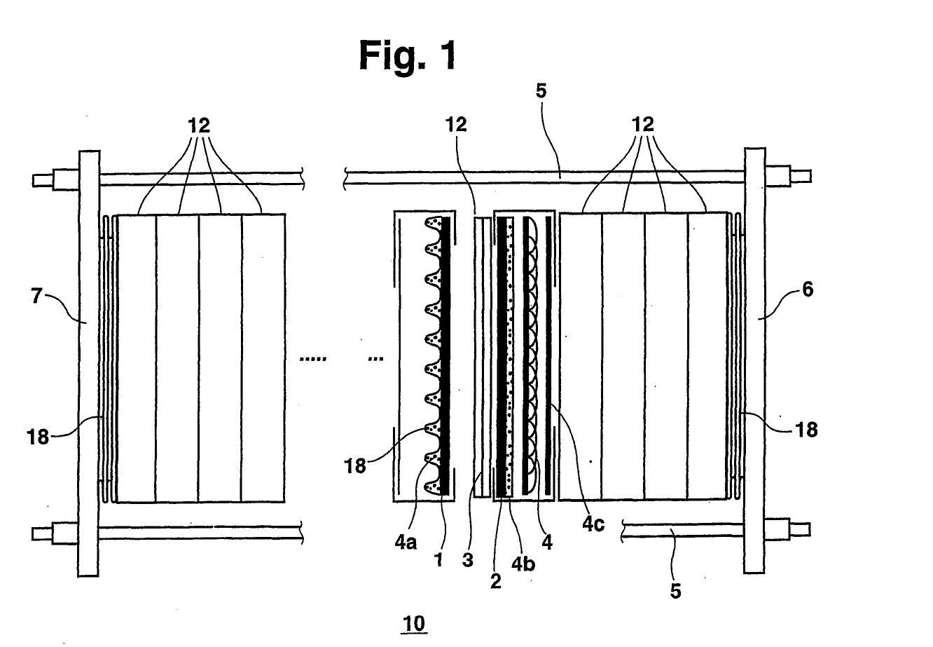

In FIG. 1 the reference numeral 10 refers altogether to a fuel cell stack, which comprises a number of fuel cells 12. Each one contains an anode 1, a cathode 2, and an electrolyte matrix 3, arranged between said anode and cathode. Adjacent fuel cells 12 are separated from one another by means of bipolar plates 4, which serve to guide the currents of a combustion gas B and a cathode gas and/or oxidation gas O, separated from one another, by way of the anode 1 and/or by way of the cathode 2 of the fuel cells 12. In so doing, the anode 1 and the cathode 2 of the adjacent fuel cells 12 are separated from one another with respect to the gas by means of the bipolar plates 4, but electrically contacted by way of the respective current collectors 4a, 4b, that is, a current collector 4a on the anode 1 and a current collector 4b on the cathode 2.

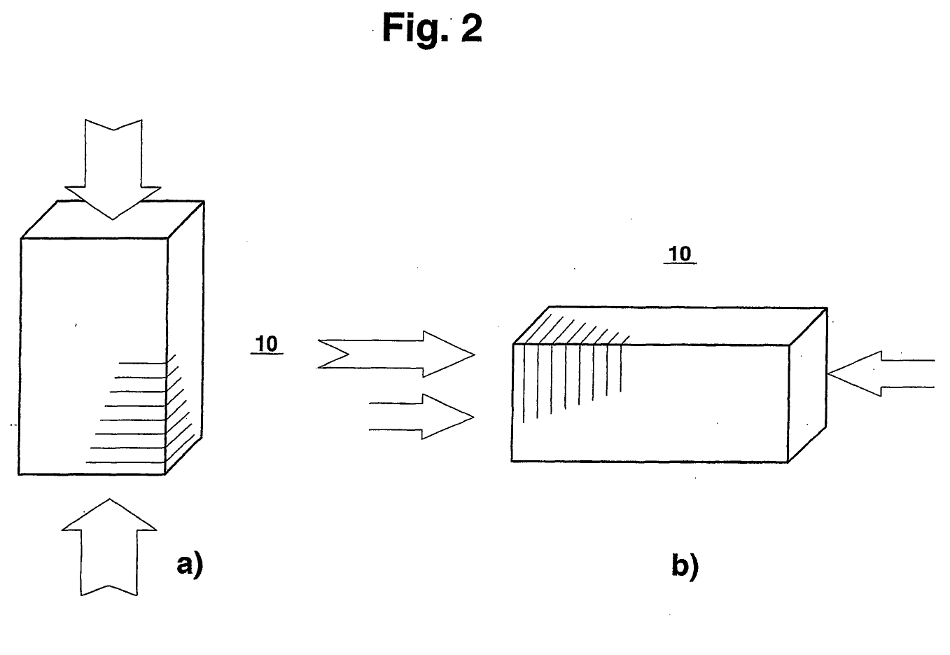

According to a significant aspect of the invention, the fuel cell stack 10 is operated horizontally, as shown in FIG. 2b. This means that all fuel cells are subjected to a uniform pre-stress and load, where the pre-stress and thus the load on the individual fuel cells are held uniform and low. The result is that there is an additional freedom with respect to the use of the individual components of the fuel cells. That is, such components can be used that would not withstand a high load. In contrast, in a fuel cell assembly with a vertically arranged fuel cell stack 10, as shown in FIG. 2a, the bottom cells are subjected to the load of the dead weight of the upper cells, in addition to the pre-stress, and thus are put under significantly more pressure than can be tolerated by the components therein. Preferably the pre-stressing force of the fuel cells 12 inside the fuel cell stack 10 is small and is variably adaptable to the operating state of the fuel cell assembly. To this end, there are generally means that produce the pre-stressing force and that at startup of the fuel cell assembly when it is put into operation produce a high pre-stressing force and subsequently reduce the pre-stressing force. Thus, at startup of the fuel cell assembly the tolerances and the effects of setting the individual components of the fuel cells can be balanced, whereas, when the fuel cell assembly is subsequently operated, a reduction in the creep of the components of the individual fuel cells 12 is achieved by means of a reduced pre-stress. The consequence is first a reduction in the lifespan limiting effects and enables secondly the use of components for the fuel cells that cannot withstand a continuous high load.

The means, generating the pre-stressing force, are formed by means of a device that subjects the fuel cell stack 10 to stress in its longitudinal direction from the outside. Such means can be formed, for example, by end plates 6, 7, which are provided on the ends of the fuel cell stack 10 and which are connected together by means of pull rods 5 and braced against one another so that the individual fuel cells 12 are held together under a specified contact pressure. To vary the pre-stressing force, the force, which the pull rods exert on the end plates, can be set. To this end, there are springs or bellows 18, whose pressure can be set variably. The bellows 18 can also be designed, for example, according to German Patent Document No. DE 198 52 362C2. In place of the bellows 18, there can be springs that are, however, not illustrated.

The interior of the fuel cell stack 10 exhibits materials, which produce an increase in volume when the fuel cell stack is put into operation. Such materials are provided especially in the fuel cells 12 and are designed in such a manner that they increase their volume at the startup of the fuel cell assembly. This feature can be induced in particular by a chemical change in the materials producing the increase in volume. In an embodiment that is described here, the materials producing an increase in volume are contained in the electrodes 1, 2, in particular in the cathodes 2 of the fuel cells 12.

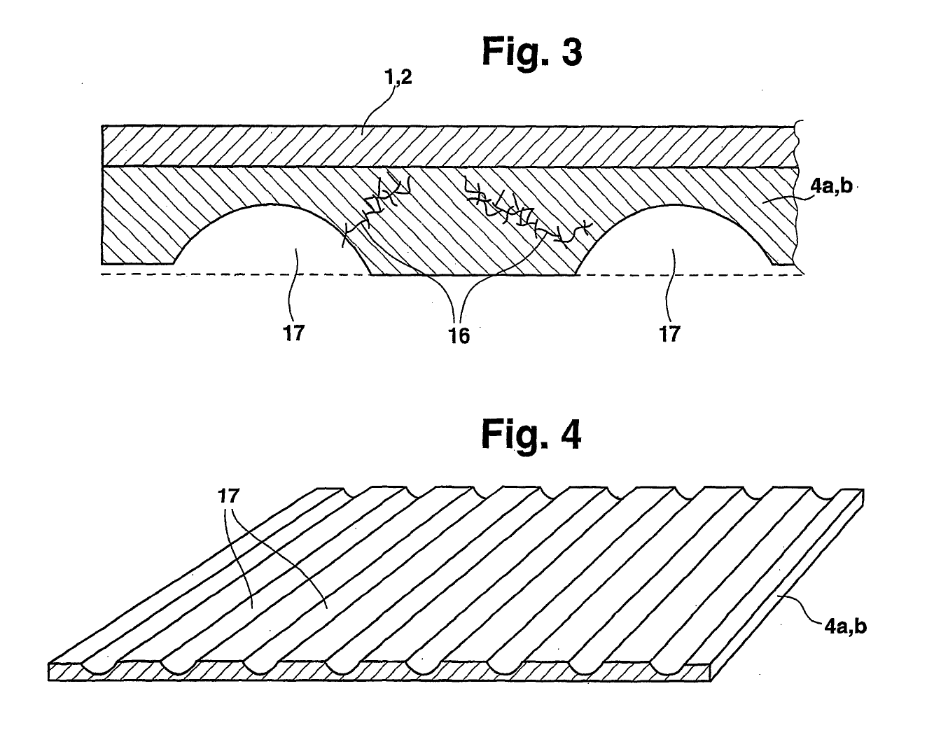

According to an embodiment of the invention, which is depicted in FIGS. 3 and 4, the materials producing an increase in volume are formed by means of a porous sintered nickel structure, which is provided on the cathodes 2 and is oxidized with a simultaneous increase in volume, when the fuel cell assembly is started. This porous sintered nickel structure exists in the form of a nickel foam material, which exhibits a solid content ranging from 4% to approximately 75%, preferably from 4% to 35%. In detail this porous sintered nickel structure forms the current collectors 4a, 4b of the electrodes 1, 2, especially the current collectors 4b of the cathodes 2. The electrodes 1, 2 are provided in the form of a layer on the porous structure forming the current collectors 4a, 4b. Thus, in particular the cathode 2 is disposed on a porous sintered nickel structure in the form of the cathode-sided current collector 4b. In so doing, at the startup of the fuel cell assembly this sintered nickel structure is oxidized while simultaneously increasing in volume, and thus generates an increase in the pre-stress inside the fuel cell and thus inside the fuel cell stack and/or balances the manufacturing tolerances and the effects of setting the individual components inside the fuel cells 12. The porous structure, forming the current collectors 4a, 4b, exhibits flow paths in the form of channels 17, which serve to guide combustion gas and/or cathode gas past the current collectors 4a, 4b (see also FIG. 4). The interior of the porous sintered nickel structure exhibits microscopic flow paths 16 owing to the porosity of the sintered nickel structure, through which the gas is transported by the channels 17 to the electrodes 1, 2 (see FIG. 3).

According to another embodiment of the invention, the materials, producing an increase in volume, can be contained in the matrices 3 of the fuel cells 12. To this end, the matrices 3 are made of base materials, which form an aluminate, in particular lithium aluminate; an oxide, in particular zirconium dioxide; and/or a zirconate, in particular lithium zirconate, when the fuel cell assembly is started. The material of the matrices that is synthesized in situ at the startup of the fuel cell assembly vanishes negatively, that is, is subjected to a macroscopic increase in volume that causes a change in the length of the matrix and thus an increase in the contact pressure. Thus, the matrix 3 can follow thermally induced expansions of the metal components, which envelop the matrix and belong to the fuel cells 12, so that no tensile stresses develop at the matrix and the matrix can burn out without forming cracks. According to one embodiment, the matrix is made of a slurry, which contains a commercially obtainable Al₂O₃ in a grain size ranging from approximately 0.5 to 0.7 μm. Further grinding thereof is not necessary. The reaction to LiAlO₂ follows by way of lithium carbonate, which decomposes into lithium oxide at higher temperatures. Furthermore, to reduce the reactive portion, lithium aluminate, originating from a pulsed reactor, is added. Moreover, the zirconium carbide, which is reacted to zirconium dioxide and later with lithium acetate to form lithium zirconate, serves to stop the shrinkage. The other components of the slurry correspond to those of a conventional slurry to produce a matrix of molten carbonate fuel cells.

The above described method for producing current collectors and/or an electrolyte matrix enables cold manufacturing the fuel cells with “green” materials without the otherwise necessary high temperature processes under controlled atmosphere. The materials are not sintered or synthesized until the fuel cell assembly is started.

According to another aspect of the invention, the pre-stress produced at the fuel cell stack 10 can be reduced after starting the fuel cell assembly. This leads to a reduction in the pre-stress and thus to a decrease in the creep of the components, contained in the fuel cells 12, owing to the reduced pre-stress pressure and thus to a reduction in the lifespan limiting effects as well as the possibility of using components, for example the porous sintered structures, described above for manufacturing the current collectors 4a, 4b, without their being damaged.

According to one aspect of the invention, the pre-stress can be reduced by balancing the tolerances and setting the components, contained in the fuel cell stack 10, that is, in particular in the fuel cells 12.

According to one alternative, the pre-stress can be reduced by reducing the pre-stress applied to the fuel cell stack 10 from outside, thus by reducing for example, the pre-stress, which is exerted by the pull rods 5 on the end plates 6,7 at the ends of the fuel cell stack 10, for example, by way of bellows 18 or springs.

1. Fuel cell assembly with fuel cells (12), which are arranged in the form of a fuel cell stack (10) and which each comprise an anode (1), a cathode (2), and an electrolyte matrix (3), arranged between said anode and cathode, and which are separated from one another by bipolar plates (4) and are electrically contacted, and which exhibit current collectors (4a) on the anodes (1) for electrically contacting the same and for guiding combustion gas to the same; and current collectors (4b) on the cathodes (2) for electrically contacting the same and for guiding cathode gas to the same; and with means for supplying and carrying away combustion gas and cathode gas to and from the fuel cells (12), as well as means that generate a prestressing force and by means of which the fuel cells (12) inside the fuel cell stack (10) are subjected to a mutual prestressing in the longitudinal direction of the fuel cell stack (10), characterized in that the current collectors (4a, 4b) are formed by means of a porous sintered nickel structure with a solid content ranging from 4% to approximately 75%, preferably 4% to 35%; that the fuel cell stack (10) is arranged horizontally at low prestressing force when in operation; and that the prestressing force of the fuel cells (12) can be variably adapted to the operating state of the fuel cell assembly.

2. Fuel cell assembly, as claimed in claim 1, characterized in that the means generating the prestressing force generate a high prestressing force at the startup of the fuel cell assembly and subsequently reduce the prestressing force.

3. Fuel cell assembly, as claimed in claim 1 or 2, characterized in that, following startup, the prestressing force is varied in such a manner that the pressure forces in the stack are held essentially equal.

4. Fuel cell assembly, as claimed in claim 1, 2, or 3, characterized in that the means generating the prestressing force are formed by means of a device (5, 6, 7, 18) that subjects the fuel cell stack (10) to prestress in its longitudinal direction from the outside.

5. Fuel cell assembly, as claimed in claim 1, 2, 3, or 4, characterized in that materials producing an increase in volume are provided in the interior of the fuel cell stack (10).

6. Fuel cell assembly, as claimed in claim 5, characterized in that the materials producing an increase in volume are provided in the fuel cells (12).

7. Fuel cell assembly, as claimed in claim 6, characterized in that the materials producing an increase in volume suffer an increase in volume at the startup of the fuel cell assembly.

8. Fuel cell assembly, as claimed in claim 7, characterized in that the increase in volume is induced by a chemical change in the materials producing an increase in volume.

9. Fuel cell assembly, as claimed in claim 8, characterized in that the materials producing an increase in volume are contained in the electrodes (1, 2) of the fuel cells (12).

10. Fuel cell assembly, as claimed in claim 9, characterized in that the materials producing an increase in volume are contained in the cathodes (2) of the fuel cells (12).

11. Fuel cell assembly, as claimed in claim 10, characterized in that the materials producing an increase in volume are made by means of a porous sintered nickel structure, which is provided on the cathodes (2) and which is oxidized with a simultaneous increase in volume, when the fuel cell assembly is started.

12. Fuel cell assembly, as claimed in claim 11, characterized in that the porous sintered nickel structure is in the form of a nickel foam material with a solid content ranging from 4% to approximately 75%, preferably 4% to 35%.

13. Fuel cell assembly, as claimed in any one of the claims 1 to 12, characterized in that the electrodes (1, 2) are provided in the form of a layer on the porous structure forming the current collectors (4a, 4b).

14. Fuel cell assembly, as claimed in any one of the claims 1 to 13, characterized in that the flow paths are provided in the form of channels (17) for guiding the combustion gas and/or the cathode gas in the porous structure forming the current collectors (4a, 4b).

15. Fuel cell assembly, as claimed in any one of the claims 8 to 14, characterized in that the materials producing an increase in volume are contained in the matrices (3) of the fuel cells (12).

16. Fuel cell assembly, as claimed in claim 15, characterized in that the matrices (3) of the fuel cells (12) are made of the base materials, which form an aluminate, in particular lithium aluminate; an oxide, in particular zirconium dioxide; and/or a zirconate, in particular lithium zirconate, when the fuel cell assembly is started.

17. Fuel cell assembly, as claimed in any one of the claims 7 to 16, characterized in that the prestress generated at the fuel cell stack (10) can be reduced, after the fuel cell assembly is started.

18. Fuel cell assembly, as claimed in claim 17, characterized in that the prestress is reduced by balancing the tolerances and setting the components, contained in the fuel cell stack (10), in particular in the fuel cells (12).

19. Fuel cell assembly, as claimed in any one of the claims 4 to 18, characterized in that the prestress is reduced by reducing the prestress applied to the fuel cell stack (10) from the outside.
